(19) United States
(12) Patent Application Publication
(10) Pub. No.: US 2026/0093922 A1
(43) Pub. Date: Apr. 2, 2026

(54) METHOD AND APPARATUS FOR NAMED ENTITY RECOGNITION, AND NON-TRANSITORY COMPUTER-READABLE RECORDING MEDIUM

(71) Applicants: Yongwei ZHANG, Beijing (CN); Bin DONG, Beijing (CN); Shanshan JIANG, Beijing (CN); Yuming ZHANG, Beijing (CN); Hongyu LI, Beijing (CN)

(72) Inventors: Yongwei ZHANG, Beijing (CN); Bin DONG, Beijing (CN); Shanshan JIANG, Beijing (CN); Yuming ZHANG, Beijing (CN); Hongyu LI, Beijing (CN)

(73) Assignee: Ricoh Company, Ltd., Tokyo (JP)

(21) Appl. No.: 19/332,733

(22) Filed: Sep. 18, 2025

(30) Foreign Application Priority Data
Sep. 27, 2024 (CN) 202411372186.3

(51) Int. Cl. G06F 40/295; G06F 40/284; G06F 40/40; G06N 3/096

(52) U.S. Cl. CPC G06F 40/295; G06F 40/284; G06F 40/40; G06N 3/096

(57) ABSTRACT

A method and an apparatus for named entity recognition, and a non-transitory computer-readable recording medium are provided. In the method, a span in a sequence to be predicted is determined, a vector representation of the sequence is generated using a pre-trained recognition model, and a vector representation of the span is obtained. Then, the vector representation of the span is compared with final representations of entity type identifiers obtained to determine an entity type of the span. The recognition model is obtained by performing fine-tuning training on a pre-trained language model based on an objective function of contrastive learning, the objective function is constructed based on vector representations of spans in training samples, so that distances between the vector representations of the spans belonging to the same class are minimized and distances between the vector representations of the spans belonging to different classes are maximized.

### CROSS-REFERENCE TO RELATED APPLICATIONS

The present application claims priority under 35 U.S.C. § 119 to Chinese Application No. 202411372186.3 filed on Sep. 27, 2024, the entire contents of which are incorporated herein by reference.

### BACKGROUND OF THE INVENTION

### 1. Field of the Invention

The present disclosure relates to the field of machine learning and natural language processing (NLP), and specifically, a method and an apparatus for named entity recognition (NER), and a non-transitory computer-readable recording medium.

### 2. Description of the Related Art

Named entity recognition (also referred to as entity recognition, entity segmentation, and entity extraction) is a fundamental task in NLP, and is an important foundational tool for NLP tasks such as information extraction, named entity recognition systems, syntactic analysis, and machine translation. Named entity recognition (also referred to as entity recognition, entity segmentation, and entity extraction) aims to locate and classify named entities in a text into predefined entity types, such as person names (usually represented by “PER”), organizational names (usually represented by “ORG”), place names (usually represented by “LOC”), time expressions, quantities, monetary values, and percentages. For ease of description, “named entities” may also be simply referred to as “entities” in this document.

In recent years, NER has primarily been approached as sequence labeling or span classification, which has many limitations. For example, it is difficult to process nested NER using sequence labeling. On the other hand, learning and inference based on span classification are complex and sensitive to noise in supervised data. Furthermore, in conventional technologies, semantic features and intermediate representations of specific classes are only learned from a source domain, which affects generalization to unseen target domains and results in suboptimal performance.

### SUMMARY OF THE INVENTION

According to an aspect of the present disclosure, a method for named entity recognition is provided. The method includes determining at least one span in a sequence to be predicted, generating a vector representation of the sequence to be predicted using a pre-trained recognition model, and obtaining a vector representation of the span in the sequence to be predicted, the number of tokens in the span being less than or equal to a preset threshold; and comparing the vector representation of a first span in the sequence to be predicted with final representations of one or more entity type identifiers obtained in advance to determine an entity type of the first span, the first span being a span among the at least one span, wherein the recognition model is obtained by performing fine-tuning training on a pre-trained language model based on an objective function of contrastive learning, the objective function is constructed based on vector representations of spans in training samples, so that distances between the vector representations of the spans belonging to the same class are minimized and distances between the vector representations of the spans belonging to different classes are maximized, the training samples include a plurality of original samples and a plurality of enhanced samples, the original samples are samples with labeled entity types, the enhanced samples are obtained by replacing one or more entities in the original samples with respective entity type identifiers, and the final representations of the entity type identifiers are obtained by performing average pooling on the vector representations of the same entity type identifier among the vector representations of the plurality of enhanced samples generated by the recognition model.

According to another aspect of the present disclosure, an apparatus for named entity recognition is provided. The apparatus includes a memory storing computer-executable instructions; and one or more processors. The one or more processors are configured to execute the computer-executable instructions such that the one or more processors are configured to determine at least one span in a generate a vector sequence to be predicted, representation of the sequence to be predicted using a pre-trained recognition model, and obtain a vector representation of the span in the sequence to be predicted, the number of tokens in the span being less than or equal to a preset threshold; and compare the vector representation of a first span in the sequence to be predicted with final representations of one or more entity type identifiers obtained in advance to determine an entity type of the first span, the first span being a span among the at least one span, wherein the recognition model is obtained by performing fine-tuning training on a pre-trained language model based on an objective function of contrastive learning, the objective function is constructed based on vector representations of spans in training samples, so that distances between the vector representations of the spans belonging to the same class are minimized and distances between the vector representations of the spans belonging to different classes are maximized, the training samples include a plurality of original samples and a plurality of enhanced samples, the original samples are samples with labeled entity types, the enhanced samples are obtained by replacing one or more entities in the original samples with respective entity type identifiers, and the final representations of the entity type identifiers are obtained by performing average pooling on the vector representations of the same entity type identifier among the vector representations of the plurality of enhanced samples generated by the recognition model.

According to another aspect of the present disclosure, a non-transitory computer-readable recording medium having computer-executable instructions for execution by one or more processors is provided. The computer-executable instructions, when executed, cause the one or more processors to carry out the method for named entity recognition. The method includes determining at least one span in a sequence to be predicted, generating a vector representation of the sequence to be predicted using a pre-trained recognition model, and obtaining a vector representation of the span in the sequence to be predicted, the number of tokens in the span being less than or equal to a preset threshold; and comparing the vector representation of a first span in the sequence to be predicted with final representations of one or more entity type identifiers obtained in advance to determine an entity type of the first span, the first span being a span among the at least one span, wherein the recognition model is obtained by performing fine-tuning training on a pre-trained language model based on an objective function of contrastive learning, the objective function is constructed based on vector representations of spans in training samples, so that distances between the vector representations of the spans belonging to the same class are minimized and distances between the vector representations of the spans belonging to different classes are maximized, the training samples include a plurality of original samples and a plurality of enhanced samples, the original samples are samples with labeled entity types, the enhanced samples are obtained by replacing one or more entities in the original samples with respective entity type identifiers, and the final representations of the entity type identifiers are obtained by performing average pooling on the vector representations of the same entity type identifier among the vector representations of the plurality of enhanced samples generated by the recognition model.

### BRIEF DESCRIPTION OF THE DRAWINGS

The above and other objects, features and advantages of the present disclosure will be further clarified the following detailed description of embodiments of the present disclosure in combination with the drawings. Note that the accompanying drawings in the following description are only some embodiments of the present disclosure, and for those skilled in the art, other drawings may also be obtained according to these drawings.

FIG. 1 is a flowchart illustrating an example of a named entity recognition method according to an embodiment of the present disclosure.

FIG. 2 is a flowchart illustrating an example of a training process of a recognition model according to the embodiment of the present disclosure.

FIG. 3 is a block diagram illustrating an example of a configuration of a named entity recognition apparatus according to another embodiment of the present disclosure.

FIG. 4 is a block diagram illustrating an example of a configuration of a named entity recognition apparatus according to another embodiment of the present disclosure.

FIG. 5 is a block diagram illustrating an example of a configuration of a named entity recognition system according to another embodiment of the present disclosure.

FIG. 6 is a block diagram illustrating an example of a hardware configuration of a computer according to another embodiment of the present disclosure.

FIG. 7 is a block diagram illustrating an example of a hardware configuration of a mobile terminal according to another embodiment of the present disclosure.

FIG. 8 is a flowchart illustrating an example of a workflow of a named entity recognition system according to another embodiment of the present disclosure.

### DESCRIPTION OF THE EMBODIMENTS

In the following, specific embodiments of the present disclosure will be described in detail with reference to the accompanying drawings, so as to facilitate the understanding of technical problems to be solved by the present disclosure, technical solutions of the present disclosure, and advantages of the present disclosure. The present disclosure is not limited to the specifically described embodiments, and various modifications, combinations and replacements may be made without departing from the scope of the present disclosure. In addition, descriptions of well-known functions and constructions are omitted for clarity and conciseness.

Note that “one embodiment” or “an embodiment” mentioned in the present specification means that specific features, structures or characteristics relating to the embodiment are included in at least one embodiment of the present disclosure. Thus, “one embodiment” or “an embodiment” mentioned in the present specification may not be the same embodiment. Additionally, these specific features, structures or characteristics may be combined in any suitable manner in one or more embodiments. The terms “first”, “second” and the like used in the present specification and claims are used to distinguish similar items and are not necessarily intended to describe a particular order or sequential sequence. It should be understood that such terms are interchangeable where appropriate, such that the embodiments of the present disclosure described herein may be implemented in orders other than those illustrated or described herein. Furthermore, the terms “include”, “have” and any variations thereof are intended to cover non-exclusive inclusions. For example, a process, a method, a system, a product, or an apparatus including a series of steps or elements is not necessarily limited to those steps or elements expressly listed, but may include other steps or elements not expressly listed or inherent to such process, method, product or apparatus. The term “and/or” used in the specification and claims refers to at least one of the connected items.

Note that steps of the methods may be performed in sequential order, however the order in which the steps are performed is not limited to a sequential order. Further, the described steps may be performed in parallel or independently.

The following description provides examples and is not intended to limit the scope, applicability, or configuration of the claims. The described functions and arrangements of the elements may be modified without departing from the spirit and scope of the present disclosure. Various examples may omit, substitute, or add various procedures or components as appropriate. For example, the described methods may be performed in an order different from that described, and various steps may be added, omitted, or combined. Furthermore, features described with reference to certain examples may be combined in other examples.

In view of the problem of the conventional technologies, an object of the embodiments of the present disclosure is to provide a method and an apparatus for named entity recognition, and a non-transitory computer-readable recording medium, which can improve the performance of named entity recognition.

In the embodiments of the present disclosure, a recognition model for named entity recognition is trained using training samples. The recognition model is used to recognize named entities in a sequence to be predicted, thereby improving the performance of the named entity recognition.

In the embodiments of the present disclosure, the training samples include a plurality of original samples and a plurality of enhanced samples. The original samples are samples with labeled entity types. The enhanced samples are obtained by replacing entities in the original samples with corresponding entity type identifiers. After training the recognition model, final representations of various entity type identifiers are generated based on the recognition model. The final representation of each entity type identifier is obtained by performing average pooling on the vector representations of the same entity type identifier among the vector representations of the plurality of enhanced samples generated by the recognition model.

The recognition model is obtained by performing fine-tuning training on a pre-trained language model based on an objective function of contrastive learning. The pre-trained language model includes, but is not limited to, any one of a BERT model, a RoBERTa model, an Ernie model, etc. The objective function is constructed based on vector representations of spans in the training samples, so that distances between the vector representations of the spans belonging to the same class are minimized and distances between the vector representations of the spans belonging to different classes are maximized.

The spans belonging to the same class include a span corresponding to a first entity in a first original sample and a span corresponding to a first entity type identifier in a first enhanced sample. The first original sample is an original sample among the plurality of original samples, the first entity is an entity in the first original sample, the first enhanced sample is an enhanced sample corresponding to the first original sample, and the first entity type identifier is an entity type identifier for replacing the first entity in the first enhanced sample.

The spans belonging to the different classes include the span corresponding to the first entity in the first original sample and a span corresponding to a non-entity in a training sample, and include the span corresponding to the first entity type identifier in the first enhanced sample and a span corresponding to a non-entity in a training sample. The non-entities refer to non-named entities. The samples may typically contain both named entities and non-named entities.

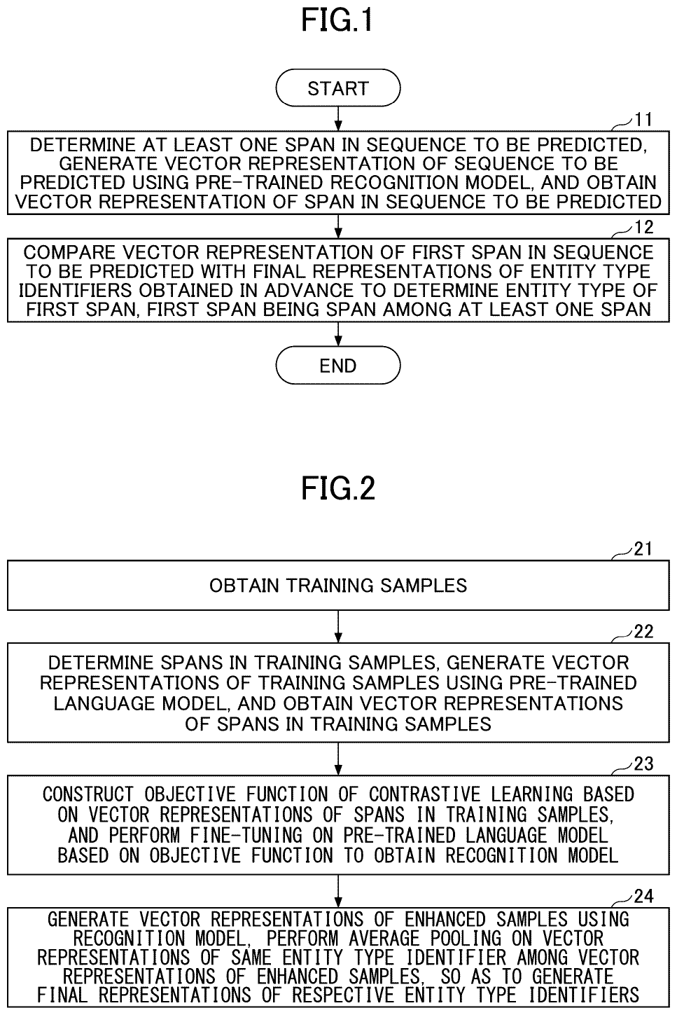

FIG. 1 is a flowchart illustrating an example of a named entity recognition method according to an embodiment of the present disclosure. As shown in FIG. 1, the named entity recognition method includes steps 11 and 12.

In step 11, at least one span in a sequence to be predicted is determined, a vector representation of the sequence to be predicted is generated using a pre-trained recognition model, and a vector representation of the span in the sequence to be predicted is obtained. The number of tokens in the span is less than or equal to a preset threshold.

Here, the sequence to be predicted may be a sentence or a text including a plurality of sentences. The sequence to be predicted includes a plurality of tokens. In this embodiment of the present disclosure, a token refers to the granularity at which the pre-trained language model processes a text, and may specifically be a single Chinese character in Chinese, a word or a subword in English, etc. The span in the sequence to be predicted is a token sequence consisting of at least one consecutive token in the sequence to be predicted, where the number of tokens contained in the span is less than or equal to a preset threshold L. The threshold L may be set based on the number of tokens contained in the longest named entity. For example, if the longest named entity contains six tokens, the threshold L may be set to 6.

When determining the at least one span in the sequence to be predicted, a continuous token sequence in the sequence to be predicted whose length is less than or equal to the threshold may be enumerated, thereby obtaining the at least one span. For example, if L=6 and the sequence to be predicted is (z₁, z₂, . . . , zₙ), where zᵢ represents the i-th token in the sequence to be predicted, the following spans may be enumerated.
spans whose length is 1 include: z₁; z₂; . . . ; zₙ;
spans whose length is 2 include: z₁z₂; z₂z₃; . . . ; zₙ₋₁zₙ;
. . . .
spans whose length is 6 include: z₁z₂z₃z₄z₅z₆; z₂z₃z₄z₅z₆z₇; . . . ; zₙ₋₅zₙ₋₄zₙ₋₃zₙ₋₂zₙ₋₁zₙ.

In step S11, the sequence to be predicted is input into the recognition model to obtain the vector representation of the sequence to be predicted generated by the recognition model. The vector representation of the sequence to be predicted includes the vector representation of each token in the sequence to be predicted. In this embodiment of the present disclosure, during the training of the recognition model, the vector representation of each token in the training sample is generated by the pre-trained language model. Then, the vector representations of the spans in the sequence to be predicted are obtained, based on the vector representation of the sequence to be predicted.

In this embodiment of the present disclosure, the vector representation of the span is generated based on a vector representation of a start token of the span, a vector representation of an end token of the span, and a vector representation of a length of the span. For example, the vector representation of the start token of the span, the vector representation of the end token of the span, and the vector representation of the length of the span are concatenated or vector computation is performed on these vector representations to obtain the vector representation of the span. The vector representation of the length of the span may be obtained by querying a pre-trained length representation matrix. The lengths have corresponding vector representations, and this embodiment of the present disclosure is not specifically limited to this example.

In step S12, the vector representation of a first span in the sequence to be predicted is compared with final representations of one or more entity type identifiers obtained in advance to determine an entity type of the first span. The first span is a span among the at least one span.

Here, similarities between the vector representation of the first span and the final representations of the entity type identifiers are calculated. Then, the entity type of the first span is determined, based on the entity type identifier with the highest similarity.

Through the above steps, the enhanced samples with similar features are constructed through data augmentation. Then a span-based contrastive learning objective is constructed using a contrastive learning algorithm. The vector representations of the entities and the vector representations of the non-entities are mapped into the same vector space, so that the distances between the vector representations of the spans belonging to the same class are minimized, and the distances between the vector representations of the spans belonging to different classes are maximized, thereby improving the generalization capability of the recognition model. In addition, in the embodiments of the present disclosure, the nested named entity recognition can be supported by introducing the spans with different lengths.

Considering that the final representations of the entity type identifiers are generated in advance and the vector representations of the non-entities are not generated in the embodiment of the present disclosure, in order to further improve the accuracy of the named entity recognition, in step S12, the highest similarity may be compared with a reference similarity, when determining the entity type of the first span based on the entity type identifier with the highest similarity. Specifically, it is determined that the entity type of the first span is a non-entity, in a case where the highest similarity is lower than a reference similarity, and it is determined that the entity type of the first span is the entity type corresponding to the entity type identifier with the highest similarity, in a case where the highest similarity is higher than or equal to the reference similarity. Here, the reference similarity isa similarity between the vector representation of the first span and a vector representation of a preset token. The preset token may be a token added by the pre-trained language model to the sequence to be predicted, such as a start identifier ([CLS]) or an end identifier ([September]) of the sequence to be predicted. The vector representation of the preset token is generated by the recognition model, and may vary in different text sequences. Thus, the reference similarity calculated based on the vector representation of the preset token is not fixed, and is actually a dynamic threshold. Based on the above reference similarity, the entities or the non-entities in the sequence to be predicted can be recognized more accurately.

Prior to step S11, the recognition model may be obtained by pre-training. In the following, the training of the recognition model in embodiments of the present disclosure is described.

FIG. 2 is a flowchart illustrating an example of a training process of a recognition model according to the embodiment of the present disclosure. As shown in FIG. 2, the training of the recognition model includes the following steps.

In step 21, the training samples are obtained.

Here, the training samples include the plurality of the original samples and the plurality of the enhanced samples. The original samples are the samples with labeled entity types, and the enhanced samples are obtained by replacing the entities in the original samples with the corresponding entity type identifiers.

Specifically, the identifiers (i.e., entity type identifiers) for various entity types may be pre-defined. For example, the entity type identifier for the entity type of a person name is <PER>, the entity type identifier for the entity type of a place name is <LOC>, and the entity type identifier for the entity type of an organization name is <ORG>. Then, each entity in the original sample is replaced with the entity type identifier of the corresponding entity type, thereby generating the enhanced sample. For example, the original sample is “Xiao Ming watched a game of the Chinese men's basketball team at Yanyuan of Peking University.” Here, the entity type of “Xiao Ming” is “PER”, the entity types of “Peking University” and “the Chinese men's basketball team” are “ORG”, and the entity type of “Yanyuan” is “LOC”. After replacing the entities in the original sample with identifiers corresponding to the entity types, the obtained enhanced sample is “<PER> watched a game of <ORG> at <LOC> of <ORG>”. It can be seen that the enhanced sample has a similar feature distribution to the original sample. Through step 21, the enhanced sample with similar features to the original sample is constructed.

In step 22, spans in the training samples are determined, vector representations of the training samples are generated using the pre-trained language model, and the vector representations of the spans in the training samples are obtained.

Here, the span is a token sequence in the training sample whose token length does not exceed a preset threshold. The threshold may be set based on the number of tokens contained in the longest named entity. In the embodiment of the present disclosure, a continuous token sequence in the training sample whose length does not exceed the threshold may be enumerated to obtain the at least one span.

In the embodiment of the present disclosure, the vector representation of the training sample may be generated using the pretrained language model. Specifically, the training sample is input into the pretrained language model, then the training sample is encoded by the pretrained language model to obtain the vector representation of the training sample (including vector representations of the tokens). The pre-trained language model includes, but is not limited to, any one of a BERT model, a ROBERTa model, an Ernie model, etc.

Then, the vector representations of the spans in the training sample are obtained, based on the vector representation of the training sample. Specifically, the vector representation of the span in the training sample is generated in the same manner as the vector representation of the span in the sequence to be predicted described above. For example, the vector representation of the span may be generated based on the vector representation of the start token of the span, the vector representation of the end token of the span, and the vector representation of the length of the span. As an implementation, the vector representation of the start token of the span, the vector representation of the end token of the span, and the vector representation of the length of the span may be concatenated or the vector computation may be performed on these vector representations to obtain the vector representation of the span. Here, the vector representation of the length of the span may be obtained by querying a pre-trained length representation matrix. The lengths have corresponding vector representations, and this embodiment of the present disclosure is not specifically limited to this example.

The vector representation of the span Sᵢⱼ obtained using vector concatenation may be expressed as follows.

$${S}_{i j} = {h}_{i} ⊕ {h}_{j} ⊕ {w}_{i j}$$

Where hᵢ is the vector representation of the start token of the span, hⱼ is the vector representation of the end token of the span, and wₗ is the vector representation of the width l of the span. Here, wₗ may be obtained by performing index querying on a pre-trained width representation matrix.

The vector representation of the span corresponding to the entity type identifier in the enhanced sample may also be generated using the above method.

In step 23, the objective function of the contrastive learning is constructed, based on the vector representations of the spans in the training samples, and the fine-tuning training is performed on the pre-trained language model based on the objective function to obtain the recognition model.

Here, by constructing the span-based contrastive learning objective, the vector representations of the entities and the non-entities are mapped into the same vector space. During the fine-tuning training of the pre-trained language model, model parameters are adjusted, so that the distances between the vector representations of the spans belonging to the same class are minimized, and the distances between the vector representations of the spans to different belonging classes are maximized, thereby training the recognition model.

The spans belonging to the same class include the span corresponding to the first entity in the first original sample and the span corresponding to the first entity type identifier in the first enhanced sample. The first original sample is the original sample among the plurality of original samples, the first entity is the entity in the first original sample, the first enhanced sample is the enhanced sample corresponding to the first original sample, and the first entity type identifier is the entity type identifier for replacing the first entity in the first enhanced sample. For example, if the original sample is “Xiao Ming watched a game of the Chinese men's basketball team at Yanyuan of Peking University.” and the first enhanced sample is “<PER> watched a game of <ORG> at <LOC> of <ORG>”, “Peking University” in the first original sample and the first <ORG> in the first enhanced sample are spans belonging to the same class. Similarly, “Peking University” in the first original sample and the second <ORG> in the first enhanced sample are also spans belonging to the same class.

The spans belonging to the different classes include the span corresponding to the first entity in the first original sample and the span corresponding to the non-entity in a training sample, and include the span corresponding to the first entity type identifier in the first enhanced sample and the span corresponding to the non-entity in the training sample. The non-entities refer to the non-named entities. The samples may typically contain both the named entities and the non-named entities.

For example, the contrastive loss lₛₚₐₙ is constructed based on an infoNEC loss function. The calculation formula of the contrastive loss lₛₚₐₙ is as follows.

$${l}_{s p a n} = - log \frac{exp ( s i m ( {S}_{i , j} , {S}_{l a b e l} ) )}{{\sum }_{{S}^{′} ∈ {S}_{no} ⋃ {S}_{i , j} ⋃ {S}_{label}} exp ( s i m ( {S}_{i , j} , {S}^{′} ) + ( s i m ( {S}_{l a b e l} , {S}^{′} ) )}$$

Where S_{i,j} represents the vector representation of the span corresponding to the entity of the entity type in the original sample, S_{label} represents the vector representation of the entity type identifier mapped to the entity type in the enhanced sequence, and Sno is the set of the vector representations of the spans corresponding to the entities of other entity types in the original samples and the enhanced samples, and the vector representations of all non-entity spans.

Based on the constructed loss function, the pre-trained language model may be fine-tuned using an AdamW optimizer to obtain a new encoding model, namely the recognition model. Thus, through the contrastive learning, the representations of the entity type is similar to the corresponding entity spans, and different from other text spans, thereby improving the generalization ability of the trained recognition model.

In step 24, the vector representations of the plurality of enhanced samples are generated using the recognition model, and the average pooling is performed on the vector representations of the same entity type identifier among the vector representations of the plurality of enhanced samples, so as to generate the final representations of the respective entity type identifiers.

After the recognition model is trained, the final representations of various entity type identifiers are generated based on the recognition model. The final representation of each entity type identifier is obtained by performing the average pooling on the vector representations of the same entity type identifier among the vector representations of the plurality of enhanced samples generated by the recognition model. The formula may be expressed as follows.

$${S}_{type} = AVGPooling ( {S}_{1} , {S}_{2} , … , {S}_{m} )$$

Where S_{type} represents the final representation of the entity type, S₁ to Sₘ are the vector representations of the same entity type in the plurality of enhanced samples, and AVGPooling represents the average pooling calculation performed on S₁ to Sₘ.

Through the above steps, the recognition model can be trained and the final vector representations of various entity types can be obtained.

Compared to the prior art, in the named entity recognition method and apparatus according to the embodiments of the present disclosure, the enhanced samples with similar features are constructed through data augmentation. Then the span-based contrastive learning objective is constructed using a contrastive learning algorithm. The vector representations of the entities and the vector representations of the non-entities are mapped into the same vector space, so that the distances between the vector representations of the spans belonging to the same class are minimized, and the distances between the vector representations of the spans belonging to different classes are maximized, thereby improving the generalization capability of the recognition model. In addition, in the embodiments of the present disclosure, the nested named entity recognition can be supported by introducing the spans with different lengths.

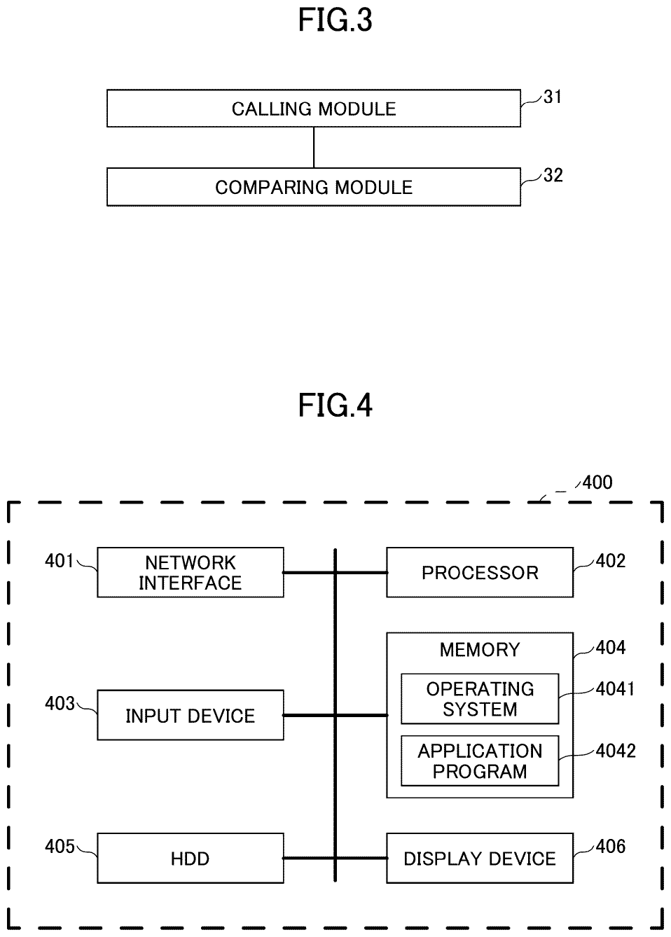

In another embodiment of the present disclosure, a named entity recognition apparatus is further provided. FIG. 3 is a block diagram illustrating an example of a configuration of a named entity recognition apparatus according to another embodiment of the present disclosure. As shown in FIG. 2, the named entity recognition apparatus includes a calling module 31 and a comparing module 32.

The calling module 31 determines at least one span in a sequence to be predicted, generates a vector representation of the sequence to be predicted using a pre-trained recognition model, and obtains a vector representation of the span in the sequence to be predicted. The number of tokens in the span is less than or equal to a preset threshold.

A comparing module 32 compares the vector representation of a first span in the sequence to be predicted with final representations of one or more entity type identifiers obtained in advance to determine an entity type of the first span. The first span is a span among the at least one span.

The recognition model is obtained by performing fine-tuning training on a pre-trained language model based on an objective function of contrastive learning, the objective function is constructed based on vector representations of spans in training samples, so that distances between the vector representations of the spans belonging to the same class are minimized and distances between the vector representations of the spans belonging to different classes are maximized. The training samples include a plurality of original samples and a plurality of enhanced samples. The original samples are samples with labeled entity types. The enhanced samples are obtained by replacing one or more entities in the original samples with respective entity type identifiers. The final representations of the entity type identifiers are obtained by performing average pooling on the vector representations of the same entity type identifier among the vector representations of the plurality of enhanced samples generated by the recognition model.

Through the above modules, named entity recognition performance can be improved.

In this embodiment of present disclosure, the spans belonging to the same class include a span corresponding to a first entity in a first original sample and a span corresponding to a first entity type identifier in a first enhanced sample. The first original sample is an original sample among the plurality of original samples, the first entity is an entity in the first original sample, the first enhanced sample is an enhanced sample corresponding to the first original sample, and the first entity type identifier is an entity type identifier for replacing the first entity in the first enhanced sample.

The spans belonging to the different classes include the span corresponding to the first entity in the first original sample and a span corresponding to a non-entity in a training sample, and include the span corresponding to the first entity type identifier in the first enhanced sample and a span corresponding to a non-entity in a training sample.

The vector representation of the span is generated based on a vector representation of a start token of the span, a vector representation of an end token of the span, and a vector representation of a length of the span.

Preferably, the comparing module 32 further calculates similarities between the vector representation of the first span and the final representations of the entity type identifiers, and determines the entity type of the first span based on the entity type identifier with the highest similarity.

Preferably, the comparing module 32 further determines that the entity type of the first span is a non-entity, in a case where the highest similarity is lower than a reference similarity, and determines that the entity type of the first span is the entity type corresponding to the entity type identifier with the highest similarity, in a case where the highest similarity is higher than or equal to the reference similarity. The reference similarity is a similarity between the vector representation of the first span and a vector representation of a preset token.

Preferably, the apparatus in the embodiment of the present disclosure further includes a training module for pre-training the recognition model. Specifically, the training module obtains the training samples. Then, the training module determines spans in the training samples, generates vector representations of the training samples using the pre-trained language model, and obtains the vector representations of the spans in the training samples. Then, the training module constructs the objective function of the contrastive learning, based on the vector representations of the spans in the training samples, and performs the fine-tuning training on the pre-trained language model based on the objective function to obtain the recognition model. Then, the training module generates the vector representations of the plurality of enhanced samples using the recognition model, and performs the average pooling on the vector representations of the same entity type identifier among the vector representations of the plurality of enhanced samples, so as to generate the final representations of the respective entity type identifiers.

It should be noted that the apparatus provided in the above embodiments corresponds to the above-mentioned named entity recognition method, and the implementation methods in the above embodiments are applicable to the embodiments of the apparatus and can achieve the same technical effects. The apparatus provided in the embodiment of the present disclosure can implement all the method steps implemented in the above-mentioned method embodiments and can achieve the same technical effects. The parts and beneficial effects of this embodiment that are identical to those of the method embodiments will not be described in detail here.

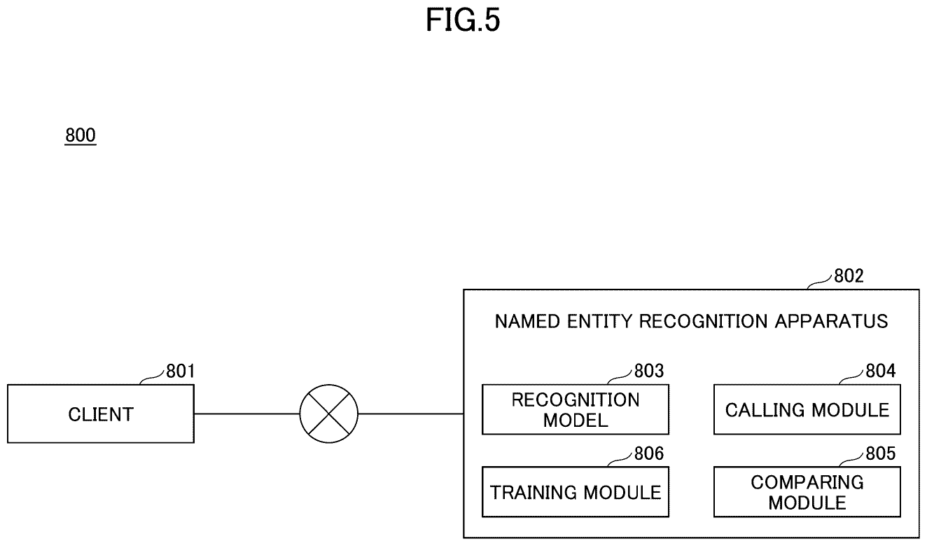

FIG. 4 is a block diagram illustrating an example of a configuration of a named entity recognition apparatus according to another embodiment of the present disclosure. As shown in FIG. 4, the named entity recognition apparatus 400 includes a processor 402, and a memory 404 storing computer-executable instructions.

When the computer-executable instructions are executed by the processor 402, the processor 402 are configured to perform the following steps.

At least one span in a sequence to be predicted is determined, a vector representation of the sequence to be predicted is generated using pre-trained recognition and model, and a vector representation of the span in the sequence to be predicted is obtained. The number of tokens in the span is less than or equal to a preset threshold.

The vector representation of a first span in the sequence to be predicted is compared with final representations of one or more entity type identifiers obtained in advance to determine an entity type of the first span. The first span is a span among the at least one span.

The recognition model is obtained by performing fine-tuning training on a pre-trained language model based on an objective function of contrastive learning. The objective function is constructed based on vector representations of spans in training samples, so that distances between the vector representations of the spans belonging to the same class are minimized and distances between the vector representations of the spans belonging to different classes are maximized. The training samples include a plurality of original samples and a plurality of enhanced samples, the original samples are samples with labeled entity types, the enhanced samples are obtained by replacing one or more entities in the original samples with respective entity type identifiers, and the final representations of the entity type identifiers are obtained by performing average pooling on the vector representations of the same entity type identifier among the vector representations of the plurality of enhanced samples generated by the recognition model.

It should be noted that the systems provided in the above embodiments are apparatuses corresponding to the above-mentioned named entity recognition method. The implementation methods in the above embodiments are applicable to the embodiments of the apparatuses and can achieve the same technical effects. The apparatus provided in the embodiments of the present disclosure can implement all the method steps implemented in the above-mentioned method embodiments and achieve the same technical effects. The parts and beneficial effects of this embodiment that are identical to those of the method embodiments will not be detailed here.

Furthermore, as shown in FIG. 4, the named entity recognition apparatus 400 further includes a network interface 401, an input device 403, a hard disk drive (HDD) 405, and a display device 406.

Each of the ports and each of the devices may be connected to each other via a bus architecture. The processor 402, such as any one of one or more central processing units (CPUs) and one or more graphics processing units (GPUS), and the memory 404, such as one or more memory units, may be connected via various circuits. Other circuits such as an external device, a regulator, and a power management circuit may also be connected via the bus architecture. Note that these devices are communicably connected via the bus architecture. The bus architecture includes a power supply bus, a control bus and a status signal bus besides a data bus. The detailed description of the bus architecture is omitted here.

The network interface 401 may be connected to a network (such as the Internet, a LAN or the like), receive data such as original training samples from the network, and store the received data in the hard disk drive 405.

The input device 403 may receive various commands input by a user, and transmit the commands to the processor 402 to be executed. The input device 403 may include a keyboard, pointing devices (such as a mouse or a track ball), a touch board, a touch panel or the like.

The display device 406 may display a result obtained by the processor 402 executing instructions, such as the progress of model training.

The memory 404 stores programs and data required for running an operating system, and data such as intermediate results in calculation processes of the processor 402.

Note that the memory 404 of the embodiments of the present disclosure may be a volatile memory or a nonvolatile memory, or may include both a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM) or a flash memory. The volatile memory may be a random access memory (RAM), which may be used as an external high-speed buffer. The memory 404 of the apparatus or the method is not limited to the described types of memory, and may include any other suitable memory.

In some embodiments, the memory 404 stores executable modules or data structure, their subsets, or their superset, i.e., an operating system (OS) 4041 and an application program 4042.

The operating system 4041 includes various system programs for implementing various essential tasks and processing tasks based on hardware, such as a frame layer, a core library layer, a drive layer and the like. The application program 4042 includes various application programs for implementing various application tasks, such as a browser and the like. A program for implementing the method according to the embodiments of the present disclosure may be included in the application program 4042.

The method according to the above embodiments of the present disclosure may be applied to the processor 402 or may be implemented by the processor 402. The processor 402 may be an integrated circuit chip capable of processing signals. Each step of the above method may be implemented by instructions in a form of integrated logic circuit of hardware in the processor 402 or a form of software. The processor 402 may be a general-purpose processor, a digital signal processor (DSP), an application specific integrated circuit (ASIC), field programmable gate array signals (FPGA) or other programmable logic device (PLD), a discrete gate or transistor logic, discrete hardware components capable of implementing or executing the methods, the steps and the logic blocks of the embodiments of the present disclosure. The general-purpose processor may be a micro-processor, or alternatively, the processor may be any common processor. The steps of the method according to the embodiments of the present disclosure may be implemented by a hardware decoding processor, or combination of hardware modules and software modules in a decoding processor. The software modules may be located in a conventional storage medium such as a random access memory (RAM), a flash memory, a read-only memory (ROM), an erasable programmable read-only memory (EPROM), an electrically erasable programmable read-only memory (EEPROM), a register or the like. The storage medium is located in the memory 404, and the processor 402 reads information in the memory 404 and implements the steps of the above methods in combination with hardware.

Note that the embodiments described herein may be implemented by hardware, software, firmware, intermediate code, microcode or any combination thereof. For hardware implementation, the processor may be implemented in one or more application specific integrated circuits (ASIC), digital signal processors (DSP), digital signal processing devices (DSPD), programmable logic devices (PLD), field programmable gate array signals (FPGA), general-purpose processors, controllers, micro-controllers, micro-processors, or other electronic components or their combinations for implementing functions of the present disclosure.

For software implementation, the embodiments of the present disclosure may be implemented by executing functional modules (such as processes, functions or the like). Software codes may be stored in a memory and executed by a processor. The memory may be implemented inside or outside the processor.

Preferably, the spans belonging to the same class include a span corresponding to a first entity in a first original sample and a span corresponding to a first entity type identifier in a first enhanced sample. The first original sample is an original sample among the plurality of original samples, the first entity is an entity in the first original sample, the first enhanced sample is an enhanced sample corresponding to the first original sample, and the first entity type identifier is an entity type identifier for replacing the first entity in the first enhanced sample. The spans belonging to the different classes include the span corresponding to the first entity in the first original sample and a span corresponding to a non-entity in a training sample, and include the span corresponding to the first entity type identifier in the first enhanced sample and a span corresponding to a non-entity in a training sample.

Preferably, the vector representation of the span is generated based on a vector representation of a start token of the span, a vector representation of an end token of the span, and a vector representation of a length of the span.

Preferably, when the computer-readable instructions are executed by the processor 402, the processor 402 is configured to calculate similarities between the vector representation of the first span and the final representations of the entity type identifiers, and determine the entity type of the first span based on the entity type identifier with the highest similarity.

Preferably, when the computer-readable instructions are executed by the processor 402, the processor 402 is configured to determine that the entity type of the first span is a non-entity, in a case where the highest similarity is lower than a reference similarity; and determine that the entity type of the first span is the entity type corresponding to the entity type identifier with the highest similarity, in a case where the highest similarity is higher than or equal to the reference similarity. The reference similarity is a similarity between the vector representation of the first span and a vector representation of a preset token.

Preferably, when the computer-readable instructions are executed by the processor 402, the processor 402 is configured to obtain the recognition model by pre-training. Specifically, the pre-training includes obtaining the training samples; determining spans in the training samples, generating vector representations of the training samples using the pre-trained language model, and obtaining the vector representations of the spans in the training samples; constructing the objective function of the contrastive learning based on the vector representations of the spans in the training samples, and performing the fine-tuning training on the pre-trained language model based on the objective function to obtain the recognition model; and generating the vector representations of the plurality of enhanced samples using the recognition model, and performing the average pooling on the vector representations of the same entity type identifier among the vector representations of the plurality of enhanced samples, so as to generate the final representations of the respective entity type identifiers.

It should be noted that the above-mentioned device provided in the embodiment of the present disclosure is capable of implementing all the method steps implemented in the above-mentioned method embodiment and achieving the same technical effects. The parts and beneficial effects of this embodiment that are identical to those in the method embodiment will not be further detailed here.

FIG. 5 is a block diagram illustrating an example of a configuration of a named entity recognition system according to another embodiment of the present disclosure. As shown in FIG. 5, the named entity recognition system 800 includes a client 801 and a named entity recognition apparatus 802.

The client 801 may be a personal computer or a mobile terminal, or an application running on any of these terminals. A mobile terminal is a terminal device operated by a user. Mobile terminals may be smartphones, personal digital assistants (PDAs), handheld devices with wireless communication capabilities, computing devices or other processing devices connected to a wireless modem, in-vehicle devices, wearable devices, and next-generation communication systems, such as terminal devices in NR networks or terminal devices in future-evolved Public Land Mobile Networks (PLMNs).

The named entity recognition apparatus 802 may be a server system consisting of one or more computers. The named entity recognition apparatus 802 runs a recognition model 803, a calling module 804, a training module 806, and a comparing module 805. The recognition model 803 may be trained by the training module 806. The training module 806 may be obtained by fine-tuning a pre-trained language model.

In the named entity recognition system 800, the client 801 may be connected to the named entity recognition apparatus 802 via a wired and/or wireless network.

The functions of the client 801 and the named entity recognition apparatus 802 may be distributed across a plurality of computers.

In the following, the hardware or software structure of the relevant devices, devices, or functions are described.

### <Hardware Structure>

### Computer:

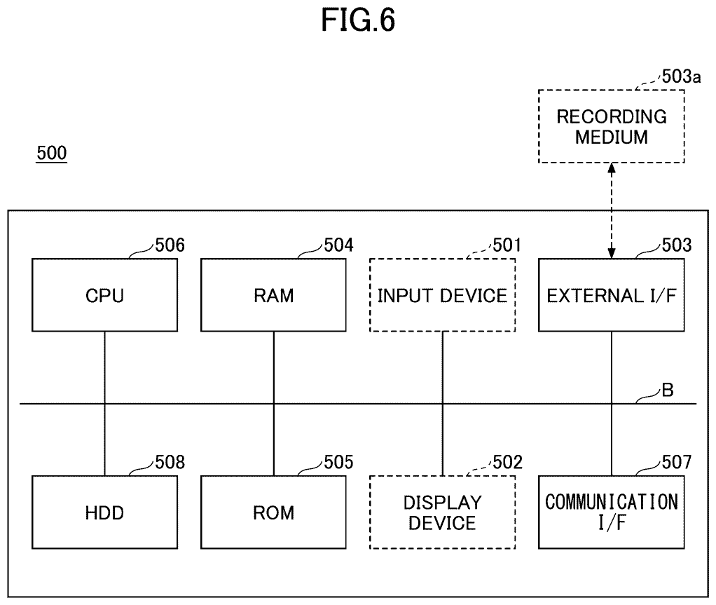

The client 801 and the named entity recognition apparatus 802 are implemented by a computer having a hardware structure, such as that shown in FIG. 6. FIG. 6 is a block diagram illustrating an example of a hardware configuration of a computer according to another embodiment of the present disclosure.

Referring to FIG. 6, a computer 500 includes an input device 501, a display device 502, an external I/F 503, a RAM 504, a ROM 505, a CPU 506, a communication I/F 507, an HDD 508, and the like, which are interconnected via a bus B. A configuration in which the input device 501 and the display device 502 are connected as necessary is acceptable.

The input device 501 includes a keyboard, a mouse, a touchpad, and the like, through which a user inputs various operation signals. The display device 502 includes a display, etc., to display processing results obtained by the computer 500.

The communication I/F 507 is an interface configured to connect the computer 500 to various networks. The computer 500 thus performs data communications via the communication I/F 507.

The HDD 508 is an exemplary nonvolatile storage device that stores programs and data. The stored data includes the operating system (OS), which is the basic software that controls the entire computer 500, and application software (hereinafter, simply referred to as “applications”) that provides various functional capabilities within the OS. The computer 500 may use a drive device that uses flash memory (e.g., a solid-state drive (SSD)) as a storage medium instead of the HDD 508.

The external I/F 503 is an interface for external devices. Examples of the external device include the recording medium 503a. In this case, the computer 500 reads information from and/or writes information to the recording medium 503a via the external I/F 503. The recording medium 503a may be a floppy disk, CD, DVD, SD memory card, or USB memory.

The ROM 505 is a nonvolatile semiconductor memory (storage device) that retains programs and/or data even when the power is off. The ROM 505 stores programs and data for the basic input/output system (BIOS), operating system settings, network settings, and the like, which are executed when the computer 500 is turned on. The RAM 504 is an example of a volatile semiconductor memory (storage device) that temporarily stores programs and/or data.

The CPU 506 is an algorithmic device which reads programs and/or data from storage devices such as the ROM 505 and the HDD 508. The read programs or data execute a process, thereby embodying the control or functional capabilities of the entire computer 500.

The client 801 and named entity recognition apparatus 802 are embodied in the hardware structure of the computer 500 shown in FIG. 6.

### Mobile Terminal:

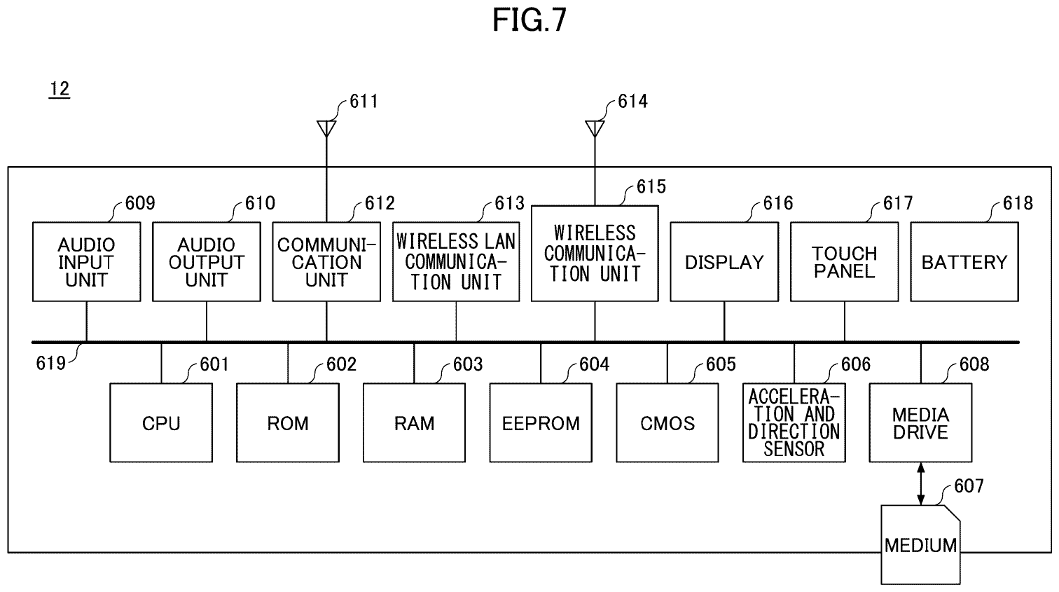

For example, the client 801 is embodied in the hardware structure shown in FIG. 7. FIG. 7 is a block diagram illustrating an example of a hardware configuration of a mobile terminal according to another embodiment of the present disclosure. The mobile terminal 12 shown in FIG. 7 includes a CPU 601, a ROM 602, a RAM 603, an EEPROM 604, a CMOS sensor 605, an acceleration and direction sensor 606, and a media drive 608.

The CPU 601 controls the overall operation of the mobile terminal 12. The ROM 602 stores basic input and output programs. The RAM 603 serves as a work area for the CPU 601. The EEPROM 604 reads or writes data in accordance with the control of the CPU 601. The CMOS sensor 605 captures image data in accordance with the control of the CPU 601. The acceleration and direction sensor 606 is an electromagnetic compass, a gyrocompass, an accelerometer, or the like that detects the magnetic force of the Earth.

The media drive 608 controls the reading or writing (storage) of data from or to a recordable medium 607, such as a flash memory. Data already stored in the recordable medium 607 is read, and new data is written to the recordable medium 607. The recordable medium 607 is freely attachable to or detachable from the media drive 608.

The EEPROM 604 stores the operating system (OS) executed by the CPU 601, associated information necessary for network configuration, and the like. Applications for executing various processes of the first embodiment are stored in the EEPROM 604, the recordable medium 607, and the like.

The CMOS sensor 605 is a charge-coupled device that converts light into electric charge to digitize an image of an object. The CMOS sensor 605 may be embodied, for example, as a charge-coupled device (CCD) sensor, as long as it can capture an image of a subject.

In addition, the mobile terminal 12 includes an audio input unit 609, an audio output unit 610, an antenna 611, a communication unit 612, a wireless LAN communication unit 613, a wireless communication antenna 614, a wireless communication unit 615, a display 616, a touch panel 617, and a bus 619.

The audio input unit 609 converts sound into an audio signal. The audio output unit 610 converts the audio signal into sound. The communication unit 612 uses the antenna 611 to communicate with the nearest base station device via wireless communication signals. The wireless LAN communication unit 613 performs wireless LAN communication with an access point in accordance with the IEEE 80411 standard. The wireless communication unit 615 performs wireless communication using the wireless communication antenna 614.

The display 616 is configured to display an image of a subject, various icons, and the like. The display 616 is made of liquid crystal, organic EL, or the like. The touch panel 617 is mounted on the display 616 and is formed of a pressure-sensitive plate or an electrostatic plate. The touch position on the display 616 is detected by a finger or a stylus pen. The bus 619 is an address bus, data bus, or other bus that electrically connects the aforementioned a plurality of units or components.

The client 801 includes a dedicated battery 618. The client 801 is powered by the battery 618. The audio input unit 609 includes a microphone for sound input. The audio output unit 610 includes a loudspeaker for sound output.

For example, the client 801 is embodied using the hardware structure shown in FIG. 7.

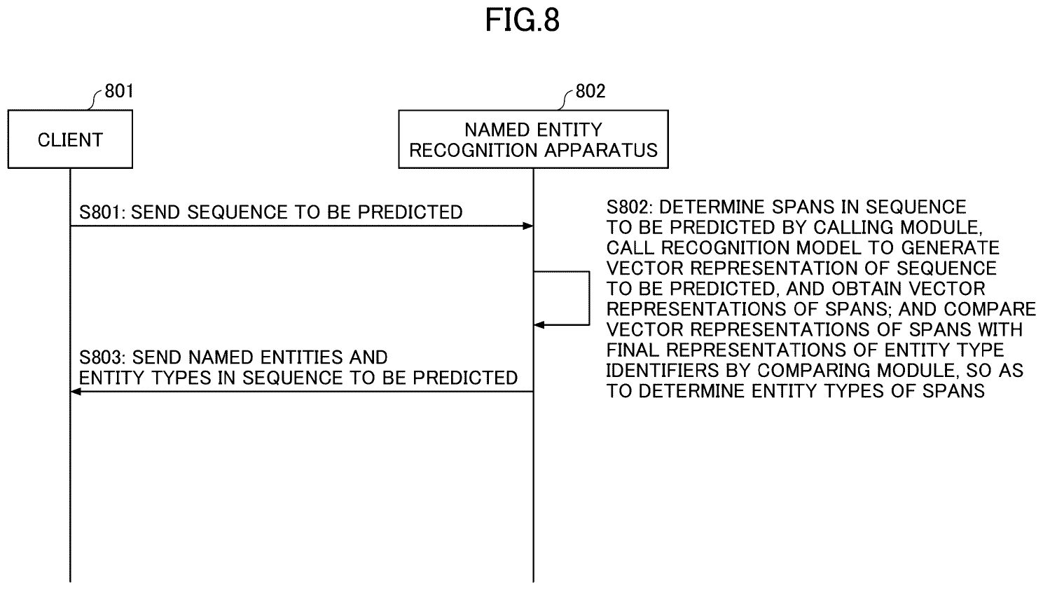

FIG. 8 is a flowchart illustrating an example of a workflow of a named entity recognition system 800 according to another embodiment of the present disclosure. In this workflow, the recognition model trained according to an embodiment of the present disclosure is used to recognize named entities, thereby improving recognition performance. The workflow specifically includes the following steps.

In S801, a user sends a sequence to be predicted to the named entity recognition apparatus 802 via the client 801. The named entity recognition apparatus 802 receives the sequence to be predicted. Specifically, the calling module may receive the sequence to be predicted.

In S802, the calling module 804 determines the spans in the sequence to be predicted, and calls the recognition model 803 to generate a vector representation of the sequence to be predicted, thereby obtaining the vector representations of the spans. The comparing module 805 compares the vector representations of spans with the final representations of the various entity type identifiers to determine the entity types of the spans.

In S803, the named entity recognition apparatus 802 sends the recognized entities and their entity types in the training sequence to be predicted to the client 801. The client 801 may display the entities and their entity types on its display device. Specifically, the client 801 may display the entities their entity types on the interface of its display device.

In another embodiment of the present disclosure, a non-transitory computer-readable recording medium having computer-executable instructions for execution by one or more processors is further provided. The execution of the computer-executable instructions cause the one or more processors to carry out a method for named entity recognition. The method includes determining at least one span in a sequence to be predicted, generating a vector representation of the sequence to be predicted using a pre-trained recognition model, and obtaining a vector representation of the span in the sequence to be predicted, the number of tokens in the span being less than or equal to a preset threshold; and comparing the vector representation of a first span in the sequence to be predicted with final representations of one or more entity type identifiers obtained in advance to determine an entity type of the first span, the first span being a span among the at least one span. The recognition model is obtained by performing fine-tuning training on a pre-trained language model based on an objective function of contrastive learning. The objective function is constructed based on vector representations of spans in training samples, so that distances between the vector representations of the spans belonging to the same class are minimized and distances between the vector representations of the spans belonging to different classes are maximized. The training samples include a plurality of original samples and a plurality of enhanced samples, the original samples are samples with labeled entity types, the enhanced samples are obtained by replacing one or more entities in the original samples with respective entity type identifiers, and the final representations of the entity type identifiers are obtained by performing average pooling on the vector representations of the same entity type identifier among the vector representations of the plurality of enhanced samples generated by the recognition model.

When executed by a processor, this program can implement all implementations of the aforementioned named entity recognition method and achieve the same technical effects. To avoid repetition, further description is omitted here.

In another embodiment of the present disclosure, a computer program product including computer instructions is further provided. When executed by a processor, the computer instructions implement each process of the aforementioned named entity recognition method embodiment and achieve the same technical effects. To avoid repetition, further description is omitted here.

As known by a person skilled in the art, the elements and algorithm steps of the embodiments disclosed herein may be implemented by electronic hardware or a combination of computer software and electronic hardware. Whether these functions are performed by hardware or software depends on the specific application and design constraints of the solution. A person skilled in the art may use different methods for implementing the described functions for each particular application, but such implementation should not be considered to be beyond the scope of the present disclosure.

As clearly understood by a person skilled in the art, for the convenience and brevity of the description, the specific working process of the system, the device and the unit described above may refer to the corresponding process in the above method embodiment, and detailed descriptions thereof are omitted here.

In the embodiments of the present disclosure, it should be understood that the disclosed apparatus and method may be implemented in other manners. For example, the device embodiments described above are merely illustrative. For example, the division of the unit is only a logical function division. In actual implementation, there may be another division manner, for example, units or components may be combined or be integrated into another system, or some features may be ignored or not executed. In addition, the coupling or direct coupling or communication connection described above may be an indirect coupling or communication connection through some interface, device or unit, and may be electrical, mechanical or the like.

The units described as separate components may be or may not be physically separated, and the components displayed as units may be or may not be physical units, that is to say, the units may be located in one place, or may be distributed across network units. Some or all of the units may be selected according to actual needs to achieve the objectives of the embodiments of the present disclosure.

In addition, each functional unit the embodiments of the present disclosure may be integrated into one processing unit, or each unit may exist physically separately, or two or more units may be integrated into one unit.

The functions may be stored in a computer readable storage medium if the functions are implemented in the form of a software functional unit and sold or used as an independent product. Based on such understanding, the technical solution of the present disclosure, which is essential or contributes to the prior art, or a part of the technical solution, may be embodied in the form of a software product, which is stored in a storage medium, including instructions that are used to cause a computer device (which may be a personal computer, a server, or a network device, etc.) to perform all or a part of the steps of the methods described in the embodiments of the present disclosure. The above storage medium includes various media that can store program codes, such as a USB flash drive, a mobile hard disk, a ROM, a RAM, a magnetic disk, or an optical disk.

The present disclosure is not limited to the specifically described embodiments, and various modifications, combinations and replacements may be made without departing from the scope of the present disclosure.

What is claimed is:

1. A method for named entity recognition, the method comprising:
determining at least one span in a sequence to be predicted, generating a vector representation of the sequence to be predicted using a pre-trained recognition model, and obtaining a vector representation of the span in the sequence to be predicted, the number of tokens in the span being less than or equal to a preset threshold; and
comparing the vector representation of a first span in the sequence to be predicted with final representations of one or more entity type identifiers obtained in advance to determine an entity type of the first span, the first span being a span among the at least one span,
wherein the recognition model is obtained by performing fine-tuning training on a pre-trained language model based on an objective function of contrastive learning, the objective function is constructed based on vector representations of spans in training samples, so that distances between the vector representations of the spans belonging to the same class are minimized and distances between the vector representations of the spans belonging to different classes are maximized, the training samples include a plurality of original samples and a plurality of enhanced samples, the original samples are samples with labeled entity types, the enhanced samples are obtained by replacing one or more entities in the original samples with respective entity type identifiers, and the final representations of the entity type identifiers are obtained by performing average pooling on the vector representations of the same entity type identifier among the vector representations of the plurality of enhanced samples generated by the recognition model.

2. The method for named entity recognition as claimed in claim 1,
wherein the spans belonging to the same class include a span corresponding to a first entity in a first original sample and a span corresponding to a first entity type identifier in a first enhanced sample, the first original sample is an original sample among the plurality of original samples, the first entity is an entity in the first original sample, the first enhanced sample is an enhanced sample corresponding to the first original sample, and the first entity type identifier is an entity type identifier for replacing the first entity in the first enhanced sample, and
the spans belonging to the different classes include the span corresponding to the first entity in the first original sample and a span corresponding to a non-entity in a training sample, and include the span corresponding to the first entity type identifier in the first enhanced sample and a span corresponding to a non-entity in a training sample.

3. The method for named entity recognition as claimed in claim 1,
wherein the vector representation of the span is generated based on a vector representation of a start token of the span, a vector representation of an end token of the span, and a vector representation of a length of the span.

4. The method for named entity recognition as claimed in claim 1,
wherein the comparing the vector representation of the first span with the final representations includes
calculating similarities between the vector representation of the first span and the final representations of the entity type identifiers, and
determining the entity type of the first span based on the entity type identifier with the highest similarity.

5. The method for named entity recognition as claimed in claim 4,
wherein the determining the entity type of the first span based on the entity type identifier with the highest similarity includes
determining that the entity type of the first span is a non-entity, in a case where the highest similarity is lower than a reference similarity; and
determining that the entity type of the first span is the entity type corresponding to the entity type identifier with the highest similarity, in a case where the highest similarity is higher than or equal to the reference similarity, and
the reference similarity is a similarity between the vector representation of the first span and a vector representation of a preset token.

6. The method for named entity recognition as claimed in claim 1, further comprising:
obtaining the recognition model by pre-training, and
the pre-training includes
obtaining the training samples;
determining spans in the training samples, generating vector representations of the training samples using the pre-trained language model, and obtaining the vector representations of the spans in the training samples;
constructing the objective function of the contrastive learning based on the vector representations of the spans in the training samples, and performing the fine-tuning training on the pre-trained language model based on the objective function to obtain the recognition model; and
generating the vector representations of the plurality of enhanced samples using the recognition model, and performing the average pooling on the vector representations of the same entity type identifier among the vector representations of the plurality of enhanced samples, so as to generate the final representations of the respective entity type identifiers.

7. An apparatus for named entity recognition, the apparatus comprising:
a memory storing computer-executable instructions; and
one or more processors configured to execute the computer-executable instructions such that the one or more processors are configured to
determine at least one span in a sequence to be predicted, generate a vector representation of the sequence to be predicted using a pre-trained recognition model, and obtain a vector representation of the span in the sequence to be predicted, the number of tokens in the span being less than or equal to a preset threshold; and
compare the vector representation of a first span in the sequence to be predicted with final representations of one or more entity type identifiers obtained in advance to determine an entity type of the first span, the first span being a span among the at least one span,
wherein the recognition model is obtained by performing fine-tuning training on a pre-trained language model based on an objective function of contrastive learning, the objective function is constructed based on vector representations of spans in training samples, so that distances between the vector representations of the spans belonging to the same class are minimized and distances between the vector representations of the spans belonging to different classes are maximized, the training samples include a plurality of original samples and a plurality of enhanced samples, the original samples are samples with labeled entity types, the enhanced samples are obtained by replacing one or more entities in the original samples with respective entity type identifiers, and the final representations of the entity type identifiers are obtained by performing average pooling on the vector representations of the same entity type identifier among the vector representations of the plurality of enhanced samples generated by the recognition model.

8. The apparatus for named entity recognition as claimed in claim 7,
wherein the spans belonging to the same class include a span corresponding to a first entity in a first original sample and a span corresponding to a first entity type identifier in a first enhanced sample, the first original sample is an original sample among the plurality of original samples, the first entity is an entity in the first original sample, the first enhanced sample is an enhanced sample corresponding to the first original sample, and the first entity type identifier is an entity type identifier for replacing the first entity in the first enhanced sample, and
the spans belonging to the different classes include the span corresponding to the first entity in the first original sample and a span corresponding to a non-entity in a training sample, and include the span corresponding to the first entity type identifier in the first enhanced sample and a span corresponding to a non-entity in a training sample.

9. The apparatus for named entity recognition as claimed in claim 7,
wherein the vector representation of the span is generated based on a vector representation of a start token of the span, a vector representation of an end token of the span, and a vector representation of a length of the span.

10. The apparatus for named entity recognition as claimed in claim 7,
wherein the one or more processors are configured to
calculate similarities between the vector representation of the first span and the final representations of the entity type identifiers, and
determine the entity type of the first span based on the entity type identifier with the highest similarity.

11. The apparatus for named entity recognition as claimed in claim 10,
wherein the or more processors are configured to
determine that the entity type of the first span is a non-entity, in a case where the highest similarity is lower than a reference similarity; and
determine that the entity type of the first span is the entity type corresponding to the entity type identifier with the highest similarity, in a case where the highest similarity is higher than or equal to the reference similarity, and
the reference similarity is a similarity between the vector representation of the first span and a vector representation of a preset token.

12. The apparatus for named entity recognition as claimed in claim 7,
wherein the one or more processors are configured to
obtain the recognition model by pre-training, and
the pre-training includes
obtaining the training samples;
determining spans in the training samples, generating vector representations of the training samples using the pre-trained language model, and obtaining the vector representations of the spans in the training samples;
constructing the objective function of the contrastive learning based on the vector representations of the spans in the training samples, and performing the fine-tuning training on the pre-trained language model based on the objective function to obtain the recognition model; and
generating the vector representations of the plurality of enhanced samples using the recognition model, and performing the average pooling on the vector representations of the same entity type identifier among the vector representations of the plurality of enhanced samples, so as to generate the final representations of the respective entity type identifiers.

13. A non-transitory computer-readable recording medium having computer-executable instructions for execution by one or more processors, wherein, the computer-executable instructions, when executed, cause the one or more processors to carry out a method for named entity recognition, the method comprising:
determining at least one span in a sequence to be predicted, generating a vector representation of the sequence to be predicted using a pre-trained recognition model, and obtaining a vector representation of the span in the sequence to be predicted, the number of tokens in the span being less than or equal to a preset threshold; and
comparing the vector representation of a first span in the sequence to be predicted with final representations of one or more entity type identifiers obtained in advance to determine an entity type of the first span, the first span being a span among the at least one span,
wherein the recognition model is obtained by performing fine-tuning training on a pre-trained language model based on an objective function of contrastive learning, the objective function is constructed based on vector representations of spans in training samples, so that distances between the vector representations of the spans belonging to the same class are minimized and distances between the vector representations of the spans belonging to different classes are maximized, the training samples include a plurality of original samples and a plurality of enhanced samples, the original samples are samples with labeled entity types, the enhanced samples are obtained by replacing one or more entities in the original samples with respective entity type identifiers, and the final representations of the entity type identifiers are obtained by performing average pooling on the vector representations of the same entity type identifier among the vector representations of the plurality of enhanced samples generated by the recognition model.

14. The non-transitory computer-readable recording medium as claimed in claim 13,
wherein the spans belonging to the same class include a span corresponding to a first entity in a first original sample and a span corresponding to a first entity type identifier in a first enhanced sample, the first original sample is an original sample among the plurality of original samples, the first entity is an entity in the first original sample, the first enhanced sample is an enhanced sample corresponding to the first t original sample, and the first entity type identifier is an entity type identifier for replacing the first entity in the first enhanced sample, and
the spans belonging to the different classes include the span corresponding to the first entity in the first original sample and a span corresponding to a non-entity in a training sample, and include the span to corresponding the first entity type identifier in the first enhanced sample and a span corresponding to a non-entity in a training sample.

15. The non-transitory computer-readable recording medium as claimed in claim 13,
wherein the vector representation of the span is generated based on a vector representation of a start token of the span, a vector representation of an end token of the span, and a vector representation of a length of the span.

16. The non-transitory computer-readable recording medium as claimed in claim 13,
wherein the comparing the vector representation of the first span with the final representations includes
calculating similarities between the vector representation of the first span and the final representations of the entity type identifiers, and
determining the entity type of the first span based on the entity type identifier with the highest similarity.

17. The non-transitory computer-readable recording medium as claimed in claim 16,
wherein the determining the entity type of the first span based on the entity type identifier with the highest similarity includes
determining that the entity type of the first span is a non-entity, in a case where the highest similarity is lower than a reference similarity; and
determining that the entity type of the first span is the entity type corresponding to the entity type identifier with the highest similarity, in a case where the highest similarity is higher than or equal to the reference similarity, and
wherein the reference similarity is a similarity between the vector representation of the first span and a vector representation of a preset token.

18. The non-transitory computer-readable recording medium as claimed in claim 13, the method comprising:
obtaining the recognition model by pre-training, and
the pre-training includes
obtaining the training samples;
determining spans in the training samples, generating representations of the training samples using the pre-trained language model, and obtaining the vector representations of the spans in the training samples;
constructing the objective function of the contrastive learning based on the vector representations of the spans in the training samples, and performing the fine-tuning training on the pre-trained language model based on the objective function to obtain the recognition model; and
generating the vector representations of the plurality of enhanced samples using the recognition model, and performing the average pooling on the vector representations of the same entity type identifier among the vector representations of the plurality of enhanced samples, so as to generate the final representations of the respective entity type identifiers.
